(19) United States
(12) Patent Application Publication
(10) Pub. No.: US 2003/0083930 A1
(43) Pub. Date: May 1, 2003

(54) VOUCHERLESS REBATE SYSTEM

(76) Inventor: BERTRAM V. BURKE, SEA BRIGHT, NJ (US)

Correspondence Address: LEO STANGER, P O BOX 1455, 382 SPRINGFIELD AVE, SUMMIT, NJ, 07901

(21) Appl. No.: 09/314,424

(22) Filed: May 18, 1999

Related U.S. Application Data
(60) Provisional application No. 60/086,011, filed on May 19, 1998.

(51) Int. Cl. G06F 17/60

(52) U.S. Cl. 705/14

(57) ABSTRACT

A purchasing system allows consumers to do their customary shopping and paying at the point of sale and simultaneously earn rebates for their favorite nonprofits. To qualify their purchases for a rebate, the shopper or nonprofit supporter provides the clerk with a transaction card that is scanned or swiped into the POS terminal (cash register). The central computer system keeps track of the amount of the purchase and the ID number. The system computes the amount of rebate and sends reports to all parties.

### REFERENCE TO RELATED APPLICATIONS

This application is a continuation-in-part of the copending provisional application Serial No. 60/086,011 filed May 19, 1999. The benefit under Title 35, United States Code, 119(e) of U.S. Provisional application Serial No. 60/086,011 filed May 19, 1999 is hereby claimed.

### FIELD OF THE INVENTION

The present application relates to a method and system to operate a consumer based voucher rebate system.

### BACKGROUND OF THE INVENTION

Traditionally, nonprofit organizations (churches, temples, Boy Scouts, PTA's, etc.) purchase discounted vouchers, in the form of paper, from merchants and resell the vouchers to their supporters at a higher price. The supporters then redeem the vouchers for goods/services provided by the issuing merchant. For example, church organization ABC pays $95 to a supermarket for $100 worth of paper vouchers, a supporter pays the church $100 for the vouchers, and then in the future the supporter redeems the paper vouchers for $100 worth of groceries. In this example, the church records and retains the $5.00 difference as a nonprofit donation.

The above outlined method of buying and selling vouchers has numerous limitations. For example, the merchants who offer nonprofit vouchers have to securely print and inventory the vouchers, market the concept, administer the program, and finally sell the vouchers to nonprofit organizations.

### SUMMARY OF THE INVENTION

An embodiment of the invention involves a clearinghouse component, a nonprofit component, a supporter component, and a merchant component. The clearinghouse component connects the other three components via a variety of entry terminals.

According to another embodiment of the invention, for example, at the time of enrollment the invention provides each supporter with an individual identification number (ID) to be used at the time of store purchase. When supporters are shopping in their usual and customary way (for example, paying for goods and/or services exactly when they receive them), the clerk enters their ID into a entry terminal (such as a cash register) by bar code, mag stripe, key stroke, or other modality.

According to another embodiment, for example, the entry terminal records the ID, as well as the amount of dollars spent in the transaction. The information is then stored and uploaded to the central clearinghouse component. At the appropriate time the central clearinghouse component reports all transaction data to the merchant component that in turn sends a rebate check to the nonprofit component.

According to another embodiment, for example, the nonprofit component receives reports provided by the clearinghouse component as to the amount of spending completed by the supporters at the store level.

### BRIEF DESCRIPTION OF THE DRAWINGS

FIG. 1 is a block diagram of system hardware and system components in FIG. 1.

FIG. 2 is a view of a card forming part of the embodiment in FIG. 1.

FIG. 3 are flow diagrams of the steps that take place when a supporter opens an individual account or looks up transaction information in the clearinghouse component FIG. 1.

FIG. 4 are flow diagrams of the steps that take place when a nonprofit opens a nonprofit account or looks up transaction information in the clearinghouse component FIG. 1.

FIG. 5 are flow diagrams of the steps that take place when a merchant opens an account or looks up transaction information in the clearinghouse component FIG. 1.

FIG. 6 are flow diagrams of the steps that take place in a point of sale computer recording supporter shopping activity and downloading to the clearinghouse component in FIG. 1.

### DETAILED DESCRIPTION OF PREFERRED EMBODIMENTS

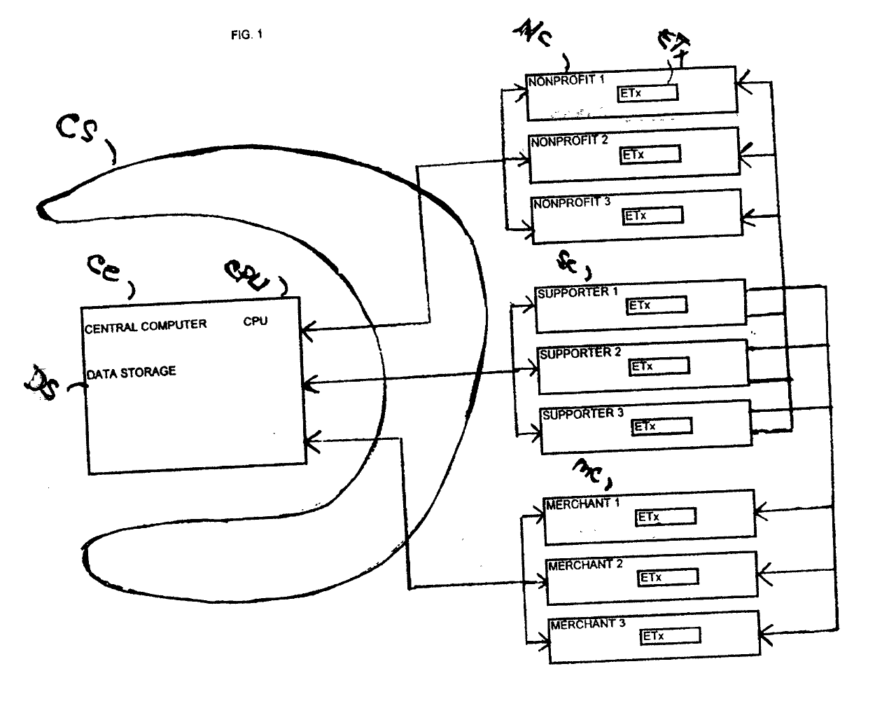

In FIG. 1, a system embodying the invention includes a hardware system having the following components: a clearinghouse component (CC) that coordinates and centralizes the activity of the other three components, a nonprofit component (NC) whose managers encourage supporters to make purchases at selected merchants, a supporter component (SC) for individuals that use a system ID when they buy goods or services at the recommended merchants, and a merchant component (MC) for merchants who agree to pay the NC rebates based upon the shopping activities of the SC.

In FIG. 1, the component CC constitutes a central computer system to: (a.) enroll nonprofits, supporters, and merchants accounts, (b.) record shopping activity, (c.) process and update accounts, (d.) calculate rebates, and (e.) provide reports for the components NC, SC, and MC.

The component CC is a system or computer that contains a central processing unit (CPU), a large data storage (DS), and a communications system (CS), i.e. telephone lines, satellites, or cables that connect the CC to a variety of entry terminals (ETx) where x=1, . . . M, . . . N) referred to terminals found in retail shops, supermarkets, gasoline stations, department stores, restaurants, specialty stores, vending machines, highway toll booths, health clinics, pay telephones, nonprofit locations, homes, Internet or Intranet networks, etc. at locations remote from the CC. Throughout this specification, the term x, when appended to the end of a reference character, is equal to 1, . . . M, . . . N.

In FIG. 1, an ETx can be an electronic cash register (ECR), point of sale (POS) terminal, draft capture device (DCR) (e.g., VeriFone), smart card reader (SCR), personal computer (PC), Internet connection (IT), plain old telephone system (POTS), or any other technical means that will allow data to be entered or accessed to the CC.

In FIG. 1, the nonprofit component(s) (NC) uses an ETx to communicate with the CC. The ETx allows the NC to: (a.) enroll in the program as a nonprofit, (b.) obtain a nonprofit account number (ID), (c.) obtain a personal identification number (PIN) needed to access its account, (d.) enroll supporters, (e.) order plastic transaction cards (TC) for its supporters to use at MC locations, (f.) enroll with one or more MC's where their supporters will shop, and (g.) request activity reports, rebate reports, and other information stored in the CC.

In FIG. 1, the supporter component(s) (SC) uses an ETx to communicate with the CC. The ETx allows the SC to: (a.) enroll in the program, (b.) obtain a supporter account number (ID), (c.) obtain a personal identification number (PIN) needed to access their account, (d.) order a plastic transaction card (TC), (e.) choose one or more NC's, (f.) select one or more MC's where they will shop, (g.) use their TC at ETx (cash registers) to connect their ID and the amount of their spending, and (h.) request activity reports, rebate reports, and other information stored in the CC.

In FIG. 1, the merchant component(s) (MC) uses an ETx to communicate with the CC. The ETx allows the MC to: (a.) enroll in the program, (b.) obtain a merchant account number (ID), (c.) obtain a personal identification number (PIN) needed to access its account, (d.) choose one or more NC's to receive rebates, (e.) enroll SC's (at the store level) and assign SC's ID's, (f.) select SC's who will qualify for rebates, (g.) determine the amount of rebate available, (h.) specify the required activity needed to qualify for a rebate, and (g.) request activity reports, rebate reports, and other information stored in the CC.

Within the scope of the invention the data collected at the point of sale can vary dependent upon the requirements set by the merchant and nonprofit. The data recorded by the store's ETx can be bar coded read (BCRx), mag stripe read (MSRx), keypad (KPx)entered, smart card read (SCR), etc. After recording the transaction information the ETx can go “on line” and send the data to the CC or save the data and send a batch transfer of multiple transactions at a latter date.

The network, instead of issuing and handling scrip, provides each supporter with an individual account, a secure personal identification number (PIN), and a card/device means to enter their ID and purchasing activity into an entry terminal (cash register). At the time of store purchasing the supporter will hand the clerk a transaction card (TC) transaction card (TC) with the ID being: (a.) bar code encoded, (b) mag stripe encoded, or (c) numerically printed on the card., activate a radio frequency device (FQ), or keystroke in their account number. Once the account number is entered, information regarding the current purchasing activity is connected to the account number to form a data packet. The data packet is stored in the cash register or entry terminal until it is batch transferred with other data packets to the CC for processing and accounts management.

The information record at the time of purchase is not limited to the following and can include any or all of the following variables: ID number, date and time of the visit, cashier entering the data, amount spent, type of tender (cash, check, credit card, smart card, gift certificate, credit card, etc.), store number, lane number.

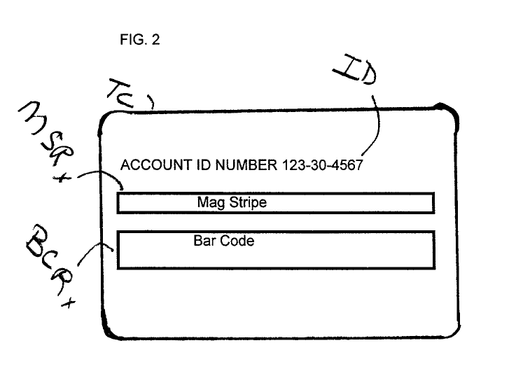

In FIG. 2, the system can use a transactional plastic card (TC), the size of traditional credit card, with either a mag stripe in configuration and/or with a bar code in configuration. In addition to the above configuration, the system ID number could be entered into ETx by keypad, smart card, radio frequency (RF) system, or a variety of other technical means.

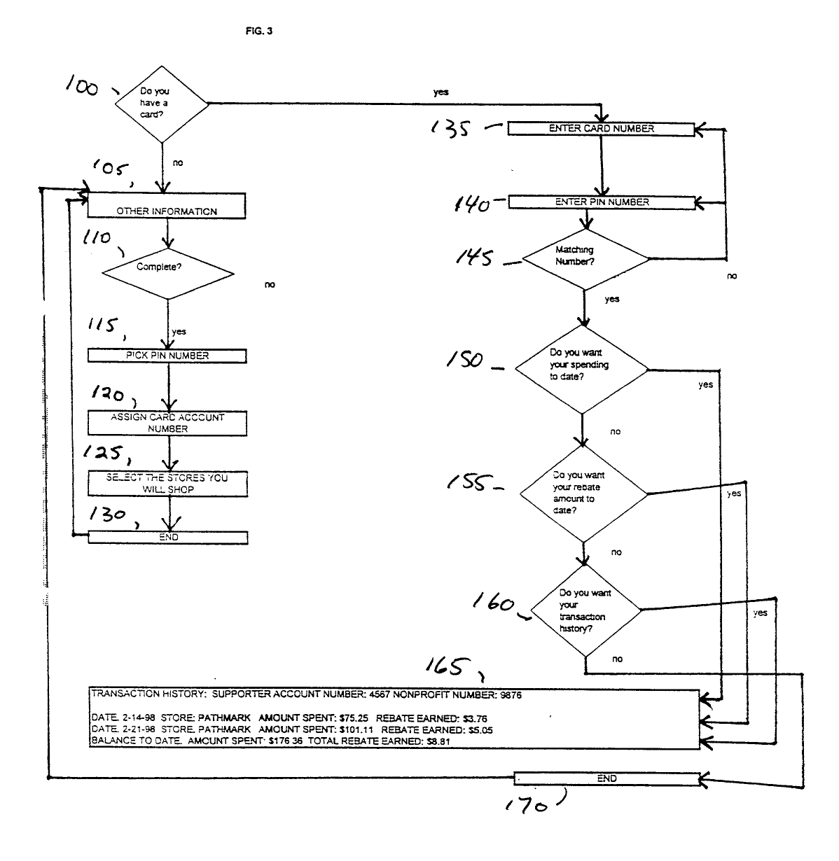

FIG. 3 is a flow chart which illustrates the steps in a computer that takes place when a supporter (an individual) applies for a supporter identification number and opens an individual supporter account in the clearinghouse computer.

In FIG. 3, in step 100, the computer CC, asks if you have a card. If the answer is no, the computer CC, in step 105 asks the supporter to enter his name, address, and other pertinent information. After completing the application, the computer CC, in step 110 asks, “Is it complete?” If not, the computer CC, returns to step 105 to obtain the needed information.

If the answer to step 110 is yes, the computer CC, in step 115 requires the supporter to select a PIN (personal identification number). After selecting a PIN, the computer CC, in step 120 assigns the supporter an account number that will be used as the ID when the supporter purchases goods or services at the store. The ID account number will be the number on their transaction card TC.

After completing step 120, the computer CC, in step 125 has the supporter indicate the stores that they intend to use their transaction card. In step 130 the enrollment process ends and the computer CC, returns to step 100.

In step 100 if the answer is yes, the computer CC, in step 135 requests the supporter enter in their account/card number. The computer CC, then goes to step 140 and requests the entry of the supporter's PIN.

In step 145, the computer CC, checks to see if the numbers match and that they correspond to an active account. If the answer is no, the computer CC, goes back to step 135 and step 140 and has the supporter re-enter their numbers. After three failed attempts, the computer returns to step 100.

If the answer to step 145 is yes, the computer CC, goes to step 150 and asks, “Do you want your spending to date?” If the answer is yes, the computer CC, goes to step 165 to access the information requested by the supporter. The computer CC then goes to step 170 to end the session and the system returns to step 100.

If the answer to step 150 is no, the computer CC, goes to step 155 and asks, “Do you want rebate amount to date?” If the answer is yes, the computer CC, goes to step 165 to access the information requested by the supporter. The computer CC then goes to step 170 to end the session and the system returns to step 100.

If the answer to step 155 is no, the computer CC, goes to step 160 and asks, “Do you want your transaction history?” If the answer is yes, the computer CC, goes to step 165 to access the information requested by the supporter. The computer CC, then goes to step 170 to end the session and the system returns to step 100. If the answer to step 160 is no, the computer CC, goes to step 170 to end the session and then returns to step 100.

In an embodiment of the invention supporters can enroll in the system by using an ETx located at a nonprofit. Under such circumstances, the NC would provide the supporter with a TC.

In alternate embodiments, a supporter can enroll and receive a TC at participating merchant's locations, directly with the CC by using a PC, or through the Internet.

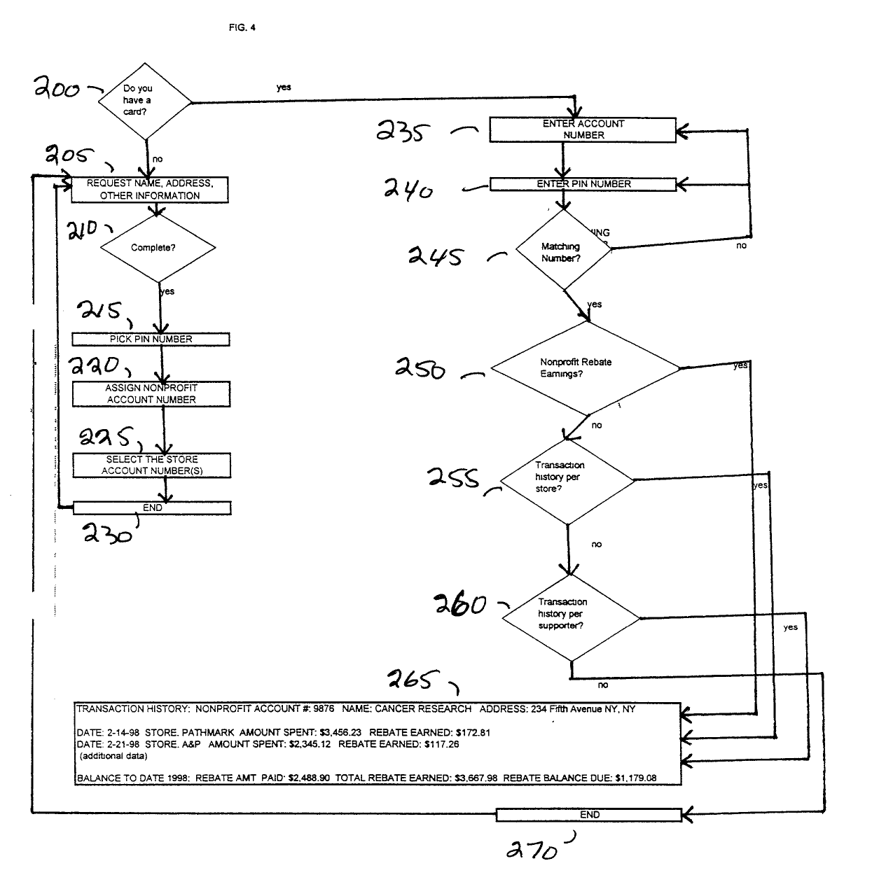

FIG. 4 is a flow chart which illustrates the steps in a computer that takes place when a nonprofit opens a nonprofit account in the central clearinghouse computer in FIG. 1.

In step 200, the computer CC, asks the nonprofit if it has an account. If the answer is no, the computer CC, in step 205 asks the nonprofit to enter its name, address, and other pertinent information. After completing the application, the computer CC, in step 210 asks, “Is it complete?” If not, the computer CC, returns to step 205 to obtain the needed information.

If the answer to step 210 is yes, the computer CC, in step 215 requires the nonprofit to select a PIN (personal identification number). After selecting a PIN, the computer CC, in step 220 assigns the nonprofit an account number that will be used as its ID when the nonprofit looks up information on its individual supporter's shopping activity, as well as the value of rebates that have been earned by its supporters.

After completing step 220, the computer CC, in step 225 has the nonprofit lists the stores that it will send its supporters to shop in and use their ID transaction card. In step 230 the enrollment process ends and the computer CC, returns to step 200.

In step 200 if the answer is yes, the computer CC, in step 235 requests the nonprofit enter in its account number. The computer CC, then goes to step 240 and requests the entry of the nonprofit's PIN.

In step 245, the computer CC, checks to see if the numbers match and that they correspond to an active account. If the answer is no, the computer CC, goes back to step 235 and step 240 and has the nonprofit re-enter its numbers. After three failed attempts, the computer returns to step 200.

If the answer to step 245 is yes, the computer CC, goes to step 250 and asks, “Rebate earnings to date?” If the answer is yes, the computer CC, goes to step 265 to access the information requested by the nonprofit. The computer CC then goes to step 270 to end the session and the system returns to step 200.

If the answer to step 250 is no, the computer CC, goes to step 255 and asks, “Transaction history per store(s)?” If the answer is yes, the computer CC, goes to step 265 to access the information requested by the nonprofit. The computer CC then goes to step 270 to end the session and the system returns to step 200.

If the answer to step 255 is no, the computer CC, goes to step 260 and asks, “Transaction history per supporter(s)?” If the answer is yes, the computer CC, goes to step 265 to access the information requested by the nonprofit. The computer CC, then goes to step 270 to end the session and the system returns to step 200. If the answer to step 260 is no, the computer CC, goes to step 270 to end the session and then returns to step 200.

In selected embodiments of the invention nonprofits can enroll in the system by contacting the CC using a PC, POTS, or the Internet.

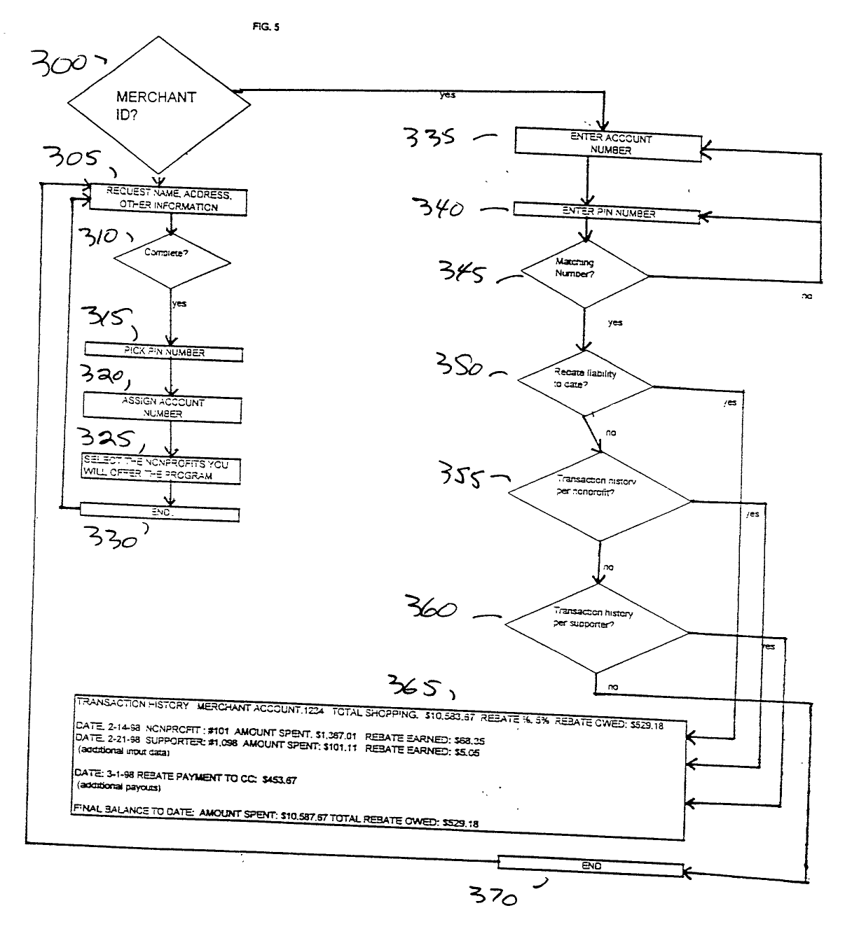

FIG. 5 is a flow chart which illustrates the steps in a computer that takes place when a merchant joins the network and when a merchant seeks transaction information from the central clearinghouse computer in FIG. 1.

In step 300, the computer CC, asks the merchant if it has an account. If the answer is no, the computer CC, in step 305 asks the merchant to enter its name, address, and other pertinent information. After completing the application, the computer CC, in step 310 asks, “Is it complete?” If not, the computer CC, returns to step 305 to obtain the needed information.

If the answer to step 310 is yes, the computer CC, in step 315 requires the merchant to select a PIN (personal identification number). After selecting a PIN, the computer CC, in step 320 assigns the merchant an account number that will be used as its ID when the merchant looks up information on nonprofits and supporters.

After completing step 320, the computer CC, in step 325 has the merchant list the nonprofit organizations (nonprofit ID's) to whom they will provide rebates. In step 330 the enrollment process ends and the computer CC, returns to step 300.

In step 300 if the answer is yes, the computer CC, in step 335 requests the merchant enter in its account number. The computer CC, then goes to step 340 and requests the entry of the merchant's PIN.

In step 345, the computer CC, checks to see if the numbers match and that they correspond to an active account. If the answer is no, the computer CC, goes back to step 335 and step 340 and has the nonprofit re-enter its numbers. After three failed attempts, the computer returns to step 300.

If the answer to step 345 is yes, the computer CC, goes to step 350 and asks, “Rebate liability to date?” If the answer is yes, the computer CC, goes to step 365 to access the information requested by the merchant. The computer CC then goes to step 370 to end the session and the system returns to step 300.

If the answer to step 350 is no, the computer CC, goes to step 355 and asks, “Rebate and shopping history per nonprofit?” If the answer is yes, the computer CC, goes to step 365 to access the information requested by the merchant. The computer CC then goes to step 370 to end the session and the system returns to step 300.

If the answer to step 355 is no, the computer CC, goes to step 360 and asks, “Rebate and shopping history per supporter?” If the answer is yes, the computer CC, goes to step 365 to access the information requested by the supporter. The computer CC, then goes to step 370 to end the session and the system returns to step 300. If the answer to step 360 is no, the computer CC, goes to step 370 to end the session and returns to step 300.

In selected embodiments of the invention merchants can enroll in the system by contacting the CC using a PC, POTS, or the Internet.

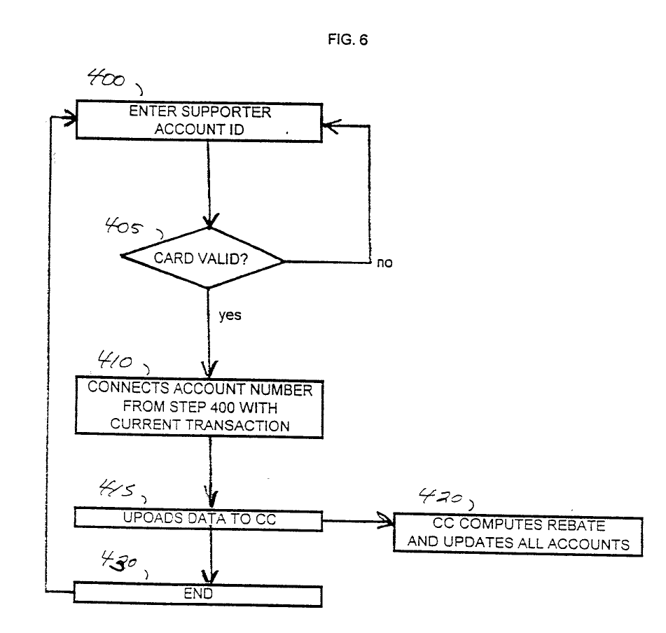

FIG. 6 is a flow chart which illustrates the steps in a entry computer (cash register) that takes place when a supporter uses their account ID at a participating merchant, and when a record of the transaction is forwarded to the central clearinghouse computer in FIG. 1.

In step 400 the supporter enters in their account number, most often by offering the clerk a plastic card (TC) to be scanned or mag stripe read. In step 405 the entry computer (cash register) determines if it is a valid card. If no, the computers go back to step 400.

If yes, in step 410 the entry computer connects the entered account number from step 400 with the current shopping transaction (date, time, location, amount spent, etc.) to form a data packet.

In step 415 the entry computer uploads the data packets to the CC.

In step 420 the CC computes the rebate factor and updates all accounts.

In step 430 the entry computer ends the session and returns to step 400.

The invention effects a more efficient nonprofit voucher system. The invention provides an orderly and more efficient system that eliminates the need for merchants to print and store vouchers, for nonprofits to purchase vouchers and resell them to supporters, and for supporters to pre-pay in advance for commodity like goods and/or services.

An advantage of the invention is that it automates an inefficient system to allow all consumers to participate in earning rebates for their favorite nonprofits. Prior to the invention only those consumers who could afford to pre-purchase vouchers, prior to going to the store, were able to participate.

By removing the need for merchants to print and securely store vouchers, for nonprofits to purchase live vouchers and resell them to supporters, and for supporters to have to pre-pay in advance for commodity goods and/or services, it is expected that many hours of unnecessary labor will be eliminated for nonprofits, supporters, and merchants. Overall, it is expected that the invention will substantially increase the use of a worthy fund raising program for nonprofits and a valuable loyalty/rewards program for merchants.

According to embodiments of the invention, nonprofit organizations need no longer initially front the cost of purchasing vouchers, securely inventory live paper vouchers, market and sell the vouchers to supporters, and generally administer the program on an ongoing basis. Supporters who might otherwise purchase the vouchers need not pre-pay for groceries prior to receiving them, nor to purchase vouchers at possibly inconvenient times at the nonprofit location, nor to securely store the paper vouchers until they redeem them, and eventually present the vouchers for payment at the time of purchase.

The execution eliminates significant market inefficiencies with a just in time cash purchasing method, an automatic and centrally coordinated data tracking system, a bank based method of tracking and dispersing donations, a fully audible system that provides information and security for all participants, and a system that is capable of handling a large audience of participants.

According to embodiments of the invention, the components operate individually while maintaining a high degree of intrasystemic harmony and, in so doing, each component simultaneously assumes the responsibility for seamless intersystemic performance.

With the invention, the components accept and interface with multiple and diverse merchants, to handle a variety of payment modalities, to define and record customer spending and loyalty behavior on a variety of platforms, to offer multiple reward programs using one on one or multiple performance requirements, to provide sophisticated and robust auditing and reporting capability for the nonprofit, the supporter, and the merchant, and to have the ability to provide services to an unlimited number of participants.

With the invention, a supporter can automatically send a rebate to a nonprofit when they make purchases at participating merchants. At participating merchants, a supporter simply enters a system ID, generally by a card, and a record of their transaction (i.e. amount spent, location, time, date, etc.) is connected to their ID and forwarded to a central clearinghouse. At the central clearinghouse the transaction data is computed to determine the amount of rebate that will be rewarded and the nonprofit organization that is due the rebate amount. Participating merchants determine the level of buying needed and the amount of rebate that will be paid to the nonprofit.

The arrangement provides an orderly and more efficient system that eliminates the need for merchants to print and store vouchers, for nonprofits to purchase vouchers and resell them to supporters, and for supporters to pre-pay in advance for commodity like goods and/or services. It allows all consumers to participate in earning rebates for their favorite nonprofits. Hitherto only those consumers who could afford to pre-purchase vouchers, prior to going to the store, were able to participate. The arrangement removes the need for merchants to print and securely store vouchers, for nonprofits to purchase live vouchers and resell them to supporters, and for supporters to have to pre-pay in advance for commodity goods and/or services.

While embodiments of the invention have been described in detail, it will be evident to those skilled in the art that the invention may be embodied otherwise without departing from its spirit and scope. Therefore, the following claims are meant to encompass all alternatives and modifications within the scope and spirit of the invention.

What is claimed is:

1. In a system having a clearinghouse component, a nonprofit component, a supporter component, and a merchant component, with the clearinghouse component connecting the other three components via a variety of entry terminals, a method comprising:
providing each of a plurality of supporters with an individual identification number (ID);
entering the ID into an entry terminal;
entering an amount spent by a supporter at a merchant in a transaction;
having the entry terminal record the ID, as well as the amount of dollars spent in a transaction;
uploading the ID and the amount entered to a central clearinghouse;
having the central clearinghouse report all transaction to the merchan for having the merchant send a rebate to the nonprofit organization.
having the clearinghouse send the nonprofit organization reports as to the amount of spending completed by the supporters at the merchant..
